(19) United States
(12) Patent Application Publication
(10) Pub. No.: US 2022/0374768 A1
(43) Pub. Date: Nov. 24, 2022

(54) APPARATUS OF MACHINE LEARNING, MACHINE LEARNING METHOD, AND INFERENCE APPARATUS

(71) Applicant: Canon Medical Systems Corporation, Otawara-shi (JP)

(72) Inventor: Hidenori TAKESHIMA, Kawasaki (JP)

(73) Assignee: Canon Medical Systems Corporation, Otawara-shi (JP)

(21) Appl. No.: 17/662,868

(22) Filed: May 11, 2022

(30) Foreign Application Priority Data
May 24, 2021 (JP) 2021-086968

(51) Int. Cl. G06N 20/00; G06K 9/62; G06N 5/04

(52) U.S. Cl. CPC G06N 20/00; G06K 9/6256; G06K 9/6262; G06N 5/04

(57) ABSTRACT

An apparatus of machine learning includes processing circuitry. The processing circuitry uses a first calibration model that receives, as input, first processing data and a first processing label assigned by a user to the first processing data and outputs calibration data relating to calibration of individual characteristics in label assignment by the first user, and trains a target model based on at least the first processing data and the calibration data or a calibrated label having individual characteristics calibrated using the calibration data.

### CROSS-REFERENCE TO RELATED APPLICATIONS

This application is based upon and claims the benefit of priority from Japanese Patent Application No. 2021-086968, filed May 24, 2021, the entire contents of which are incorporated herein by reference.

### FIELD

Embodiments described herein relate generally to an apparatus of machine learning, a machine learning method, and an inference apparatus.

### BACKGROUND

Machine learning requires a large number of labels. In machine learning with the use of medical data such as a medical image, for example, labels are manually assigned to medical data. A large number of labels is prepared by a single person or few people in some cases and by many people in others. When individual differences appear in label assignment, labels are low in reliability and machine learning is inferior in accuracy.

### BRIEF DESCRIPTION OF THE DRAWINGS

FIG. 1 is a diagram showing a configuration example of an apparatus of machine learning according to a present embodiment.

FIG. 2 is a diagram showing individual differences in label assignment.

FIG. 3 is a diagram showing a flow of an exemplary training process of a calibration model according to a first example.

FIG. 4 is a diagram schematically showing a flow of an exemplary training process of a calibration model according to the first example.

FIG. 5 is a diagram showing a flow of an exemplary training process of a target model according to the first example.

FIG. 6 is a diagram schematically showing a flow of an exemplary training process of a target model according to the first example.

FIG. 7 is a diagram showing an exemplary positional relationship between an assigned label and a calibration label.

FIG. 8 is a diagram showing a flow of an exemplary training process of a calibration model according to a second example.

FIG. 9 is a diagram schematically showing a flow of an exemplary training process of a calibration model according to the second example.

FIG. 10 is a diagram showing a flow of an exemplary training process of a target model according to the second example.

FIG. 11 is a diagram schematically showing a flow of the exemplary training process of the target model according to the second example.

FIG. 12 is a diagram showing a flow of an exemplary training process of a calibration model according to a third example.

FIG. 13 is a diagram schematically showing a flow of an exemplary training process of a calibration model according to the third example.

FIG. 14 is a diagram showing a flow of an exemplary training process of a target model according to the third example.

FIG. 15 is a diagram schematically showing a flow of an exemplary training process of a target model according to the third example.

FIG. 16 is a diagram schematically showing an exemplary process performed by an apparatus of machine learning according to a first application example.

FIG. 17 is a diagram showing a calibration example of individual characteristics in label assignment by a first user and a second user.

FIG. 18 is a diagram showing a configuration example of a blend network according to a third application example.

FIG. 19 is a diagram showing an example of individual characteristics in label assignment by the first user and the second user, according to a task for estimation of imaging slice.

FIG. 20 is a diagram showing an example of individual characteristics in label assignment by the first user and the second user, according to a task of abnormality detection.

FIG. 21 is a diagram showing a configuration example of an inference apparatus.

FIG. 22 is a diagram showing an input/output relationship of a target model.

### DETAILED DESCRIPTION

An apparatus of machine learning according to an embodiment includes processing circuitry. The processing circuitry is configured to train, by using a first calibration model that receives, as input, first processing data and a first processing label assigned by a first user to the first processing data, and outputs calibration data relating to calibration of individual characteristics in label assignment by the first user, a target model based on at least the first processing data and the calibration data or a calibration label having individual characteristics calibrated using the calibration data.

Hereinafter, an embodiment of an apparatus of machine learning, a machine learning method, and an inference apparatus will be described in detail with reference to the drawings.

The apparatus of machine learning according to the present embodiment corresponds to a computer configured to learn a machine learning model using labels. The label indicates information indicative of an answer assigned to input data relating to machine learning. The label may take various forms depending on the task of a machine learning model as a training target. The task of a machine learning model may be of any form such as classification, regression, object detection, image generation, etc. As the machine learning model according to the present embodiment, any of a neural network, a support vector machine, a random forest, etc., may be adopted. The machine learning model of a training target according to the present embodiment will be referred to as a “target model”. An inference apparatus according to the present embodiment corresponds to a computer configured to make an inference using the target model used to train the apparatus of machine learning.

The apparatus of machine learning according to the present embodiment utilizes a machine learning model for calibrating individual characteristics in label assignment for each user who assigns a label. Hereinafter, such a machine learning model will be referred to as a “calibration model”. “Individual characteristics” indicates an individual habit in label assignment by a user or an individual difference in label assignment between users. The apparatus of machine learning according to the present embodiment executes machine learning of a target model while performing calibration, by using a calibration model, on individual characteristics in a label assigned by a user.

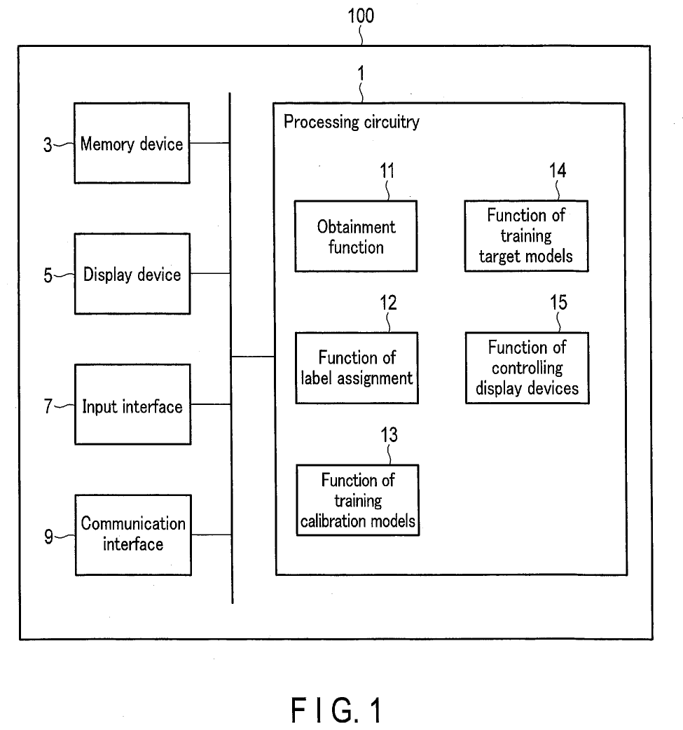

FIG. 1 is a diagram showing a configuration example of an apparatus of machine learning 100 according to the present embodiment. As shown in FIG. 1, the apparatus of machine learning 100 includes processing circuitry 1, a memory device 3, a display device 5, an input interface 7, and a communication interface 9. The processing circuitry 1, the memory device 3, the display device 5, the input interface 7, and the communication interface 9 perform data communications with each other via a bus.

The processing circuitry 1 includes a processor such as a central processing unit (CPU). The processor activates various programs installed on the memory device 3, etc., thereby implementing an obtainment function 11, a function of label assignment 12, a function of training calibration models 13, a function of training target models 14, and a function of controlling display devices 15, etc. The functions 11 to 15 are not limited to those implemented by a single processing circuit. A plurality of independent processors may be combined into processing circuitry, and each of the processors may execute the programs to implement the functions 11 to 15.

By implementing the obtainment function 11, the processing circuitry 1 obtains data targeted for label assignment. Data to be obtained is divided into data for training of a target model and data for training of a calibration model. Data for use in training of a target model will be generically referred to as “target training data”, and data for use in training of a calibration model will be generically referred to as “calibration training data”. Types of data targeted for label assignment are not particularly limited. Data targeted for label assignment may be any data of one or more dimensions. That is, data targeted for label assignment may be any of image data, text data, and waveform data, or data obtained by combining the three.

By implementing the function of label assignment 12, the processing circuitry 1 assigns a label to data obtained by the obtainment function 11. “Assigning” indicates superimposing a label on data or correlating data with a label. A label assigned to the target training data will be referred to as a “target training label”, and a label assigned to the calibration training data will be referred to as a “calibration training label”. A label assignment operation is performed by a user assigning a label to data via the input interface 7. The processing circuitry 1 assigns a label to data in accordance with a user's instruction via the input interface 7.

By implementing the function of training calibration models 13, the processing circuitry 1 trains a calibration model for calibrating individual characteristics in label assignment by a user based on calibration training data and a calibration training label assigned by the user to the calibration training data. The calibration model is trained to receive calibration training data and calibration training label as input and to output calibration data. The calibration data is data relating to calibration of individual characteristics in label assignment by a user. Input and output of the calibration model or the calibration data take various forms. A user indicates a person who assigns a label.

By implementing the function of training target models 14, the processing circuitry 1 trains a target model based on target training data, a target training label assigned by a user to the target training data, and a calibration model for the user. More specifically, the processing circuitry 1 trains a target model based on target training data and calibration data or a calibration label having individual characteristics calibrated using the calibration data. The target model is a machine learning model trained to receive input data as input and output inference data corresponding to the input data. The inference data is data obtained by performing conversion in accordance with a task of the target model on the input data. There are various training methods of the target model depending on the input and output forms of the calibration model, that is, the form of the calibration data.

By implementing the function of controlling display devices 15, the processing circuitry 1 causes the display device 5 to display various types of information. For example, the processing circuitry 1 causes target training data, calibration training data, a target training label, a calibration training label, etc., to be displayed.

The memory device 3 is a memory device configured to store various types of data, such as a read-only memory (ROM), a random-access memory (RAM), a hard disk drive (HDD), a solid state drive (SSD), and an integrated circuit memory device. Other than such memory devices, the memory device 3 may be any one or a combination of portable memory devices such as a compact disc (CD), a digital versatile disc (DVD), and a flash memory, or a driver that reads and writes various types of information in cooperation with semiconductor memory devices.

The display device 5 displays various types of data in accordance with the function of controlling display devices 15 of the processing circuitry 1. As the display device 5, a liquid crystal display (LCD), a cathode ray tube (CRT) display, an organic electroluminescence display (OELD), a plasma display, or any other display can be used as appropriate. Alternatively, the display device 5 may be a projector.

The input interface 7 accepts various input operations from a user, converts the accepted input operations into electric signals, and outputs the electric signals to the processing circuitry 1. Specifically, the input interface 7 is coupled to an input device such as a mouse, a keyboard, a track ball, a switch, a button, a joystick, a touch pad, and a touch panel display. The input interface 7 outputs the electric signals to the processing circuitry 1 according to an input operation on the input interface 7. The input device coupled to the input interface 7 may be an input device provided on another computer and coupled via a network, etc. The input interface 7 may also be a voice recognition device configured to convert voice signals collected via a microphone into command signals.

The communication interface 9 is an interface coupled to various computers via a local area network (LAN), etc. A LAN card, a network adopter, a network interface card, etc., are used as the communication interface 9. For example, the communication interface 9 performs data communication with a generation device of target training data or calibration training data and a memory device.

Next, details of the apparatus of machine learning 100 according to the present embodiment will be described.

First, individual characteristics in label assignment by a user will be described. In the example described in the following, data for use in label assignment is medical data generated by a medical device. The medical device may be a single-modality apparatus or a composite-modality apparatus. Examples of the single-modality apparatus include an X-ray computed tomography apparatus (X-ray CT apparatus), a magnetic resonance imaging apparatus (MRI apparatus), an X-ray diagnostic apparatus, a positron emission tomography (PET) apparatus, a single photon emission CT (SPECT) apparatus, an ultrasonic diagnostic apparatus, an optical interference tomography apparatus (a fundus camera), and an optical ultrasonic diagnostic apparatus. Examples of the composite-modality apparatus include a PET/CT apparatus, a SPECT/CT apparatus, a PET/MRI apparatus, and a SPECT/MRI apparatus.

As described above, the target model according to the present embodiment may execute any task as long as it is a machine learning model that is trained using a label. As an example, a task of the target model in the following description is position detection of a measurement voxel, performed by inputting a medical image and outputting a position of a measurement voxel serving as a data collection region of an MR spectroscopy with a magnetic resonance imaging apparatus. A medical image is an example of input data to a target model, while a position of a measurement voxel is an example of prediction data output from the target model. Data for use in a label assignment is an MR image in which a measurement voxel of a magnetic resonance imaging apparatus is set. A label is a mark indicative of a position of a measurement voxel.

MR spectroscopy methods include a single voxel method in which data collection is performed on a single voxel and a multi-voxel method in which data collection is performed on a plurality of voxels. The present embodiment is applicable to both methods; however, the following will describe a case in which the MR spectroscopy adopts the single voxel method.

The MR spectroscopy by the single voxel method is performed in the following procedure. First, pre-scanning called “local shimming” is performed on a measurement region of about 10 centimeters square. A magnetic field distribution in the measurement region can be obtained by this local shimming. In many cases, data collection time in local shimming is 1 minute or less. After local shimming, a measurement voxel of the MR spectroscopy is set. The measurement voxel is set to a relatively narrow region of about 1 to 2 centimeters square. A user such as a medical staffer observes an MR image and sets a lesion such as a tumor to a measurement target of the MR spectroscopy. For example, a user operates an input device such as a mouse and a stylus, thereby setting an ROI mark at a position of a measurement target included in a head MR image. A voxel indicated by the ROI mark is set to a measurement voxel. The MR spectroscopy is performed on the measurement voxel. In many cases, data collection time in the MR spectroscopy is relatively long, about 4 to 5 minutes.

Due to a measurement target being relatively small, etc., the setting of a measurement voxel is a relatively difficult operation. A target model is generated to automate this operation. The target model is a machine learning model that receives an MR image as input and outputs a position of a measurement voxel. A large volume of training samples needs to be prepared for machine learning of the target model. The training sample is a combination of an input training sample and an output training sample. The input training sample is target training data to be input to a target model. The output training sample is a label. In the present embodiment, the input training sample is an MR image while the output training sample is an ROI mark indicative of a position of a measurement voxel. The label is manually assigned to the MR image.

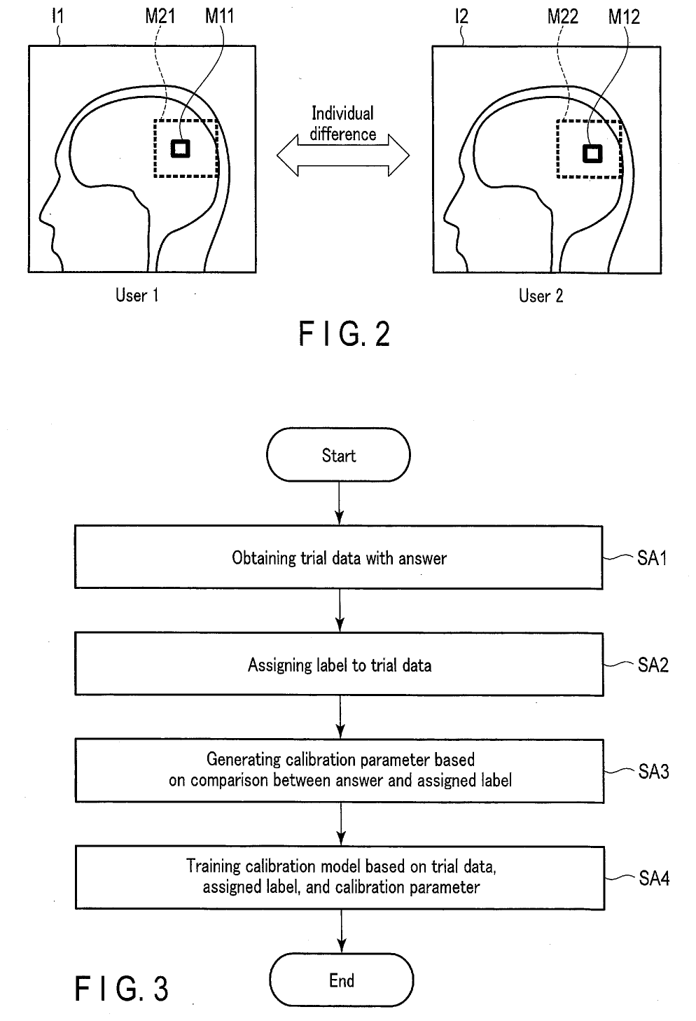

FIG. 2 is a diagram showing the individual difference in label assignment. As shown in FIG. 2, users 1 and 2 observe head MR images I1 and I2 in which lesions such as a tumor are respectively drawn, and manually assign ROI marks M11 and M12 as labels in such a manner as to surround the lesions. FIG. 2 assumes that the head MR image I1 and the MR image I2 are the same images. However, the head MR image I1 and the MR image I2 are not necessarily the same images and may be different images. The ROI marks M11 and M12 are respectively set inside ROI marks M21 and M22 indicative of measurement regions of local shimming. The left part of FIG. 2 illustrates the ROI mark M11 assigned by the user 1 while the right part of FIG. 2 illustrates the label M12 assigned by the user 2. FIG. 2 assumes that positions of the ROI mark M21 and M22 are the same between the left part and the right part.

As shown in FIG. 2, even in the case of the users 1 and 2 respectively assigning the ROI marks M11 and M12 to the same head MR images I1 and I2, the ROI marks M11 and M12 are assumed to be different in terms of time, size, etc. This may cause individual differences in label assignment. It is considered that individual differences are caused by the individual characteristics in label assignment, present for each user. For example, in the case where the centers of the ROI marks M21 and M22 are true correct label positions, there is a tendency for the user 1 to assign the ROI mark M11 to the left side and for the user 2 to assign the ROI mark M12 to the lower side. Such a rough difference in tendency in label assignment between users is classified as a “bias”. Furthermore, for example, even by the same user 1 or 2, the ROI mark M11 or M12 may vary in form depending on the position or type of a lesion. Such a difference in label assignment by the same user is classified as a “variation”. Individual characteristics is a concept that includes a bias and a variation. Under the presence of individual characteristics, the ROI marks M11 and M12 deviate from expected values, thereby increasing the possibility of decreased machine learning accuracy when the ROI marks M11 and M12 are used.

The apparatus of machine learning 100 according to the present embodiment calibrates the individual characteristics for each user by using the calibration model and performs machine learning on the target model. The processing of the apparatus of machine learning 100 is divided into a training stage for the calibration model and a training stage for the target model. A combination of the training stage for the calibration model and the training stage for the target model can be divided into various examples in accordance with output and input of the calibration model. Hereinafter, operation examples of the apparatus of machine learning 100 will be described by dividing them into various examples.

The following various examples assume that the calibration training data for use in machine learning of the calibration model is trial data. The trial data is the calibration training data assigned a label for use in machine learning of the calibration model. The following description assumes that the trial data is an MR image which may be generated by actually imaging a patient or phantom with a magnetic resonance imaging apparatus, or may be a pseudo-MR image artificially generated through image processing or prediction calculation. Furthermore, the following examples assume that the target training data for use in learning of the target model is real data. The real data is the target training data assigned a label for use in machine learning in the target model. It is assumed that the real data is an MR image generated by actually imaging a patient with a magnetic resonance imaging apparatus. An example of a task of the target model is assignment of a label indicative of a measurement voxel of MR spectroscopy. Furthermore, it is assumed that a user targeted for calibration is a first user.

### FIRST EXAMPLE

A calibration model according to a first example is a machine learning model that receives, as input, input data and a label assigned to the input data and outputs a calibration parameter. The calibration parameter is an example of calibration data output from the calibration model. By implementing the function of training calibration models 13, the processing circuitry 1 calculates a calibration parameter for calibrating the individual characteristics in label assignment by a user from a calibration training label assigned by the user to calibration training data, inputs input data based on the calibration training data, the calibration training label, and the calibration parameter, and outputs a calibration parameter corresponding to the input data. The target model according to the first example is trained based on input data, an assigned label, and a calibration label in which the assigned label is calibrated with a calibration parameter. By implementing the function of training target models 14, the processing circuitry 1 generates a calibration parameter with respect to a target training label by applying a calibration model to target training data and the target training label, generates a calibration label by applying the calibration parameter to the target training label, and trains a target model based on the target training data and the calibration label. First, a training method of the calibration model according to the first example will be described.

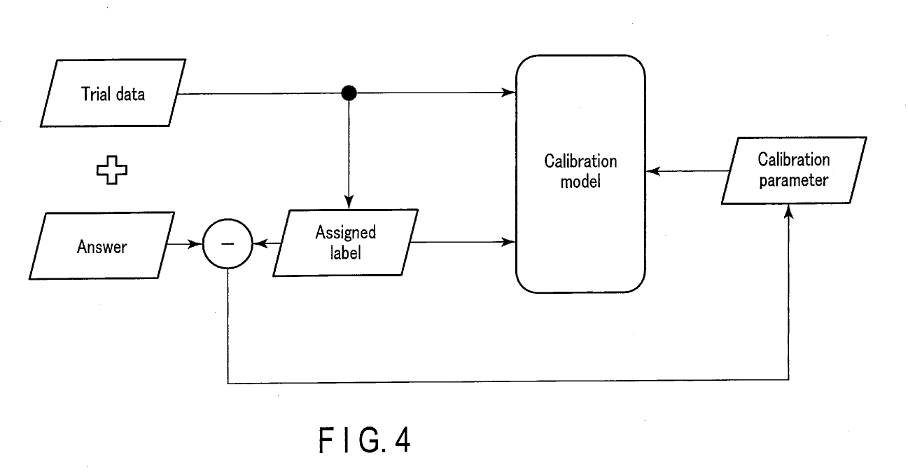

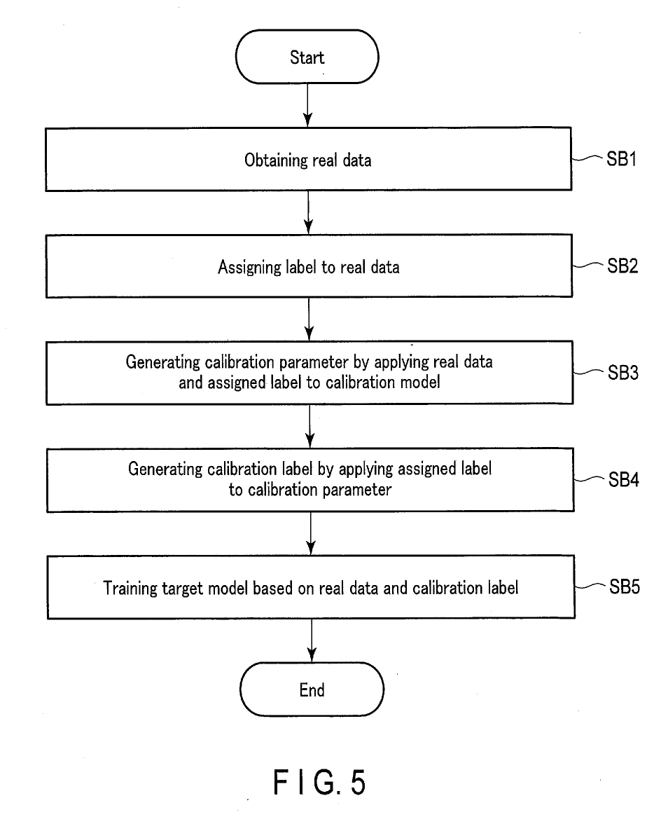

FIG. 3 is a diagram showing a flow of an exemplary training process of the calibration model according to the first example. FIG. 4 is a diagram schematically showing a flow of an exemplary training process according to the first example.

As shown in FIG. 3 and FIG. 4, by implementing the obtainment function 11, the processing circuitry 1 obtains trial data with an answer (step SA1). The trial data with an answer is trial data from which an answer regarding label assignment is either recognized or recognizable. An example used as the trial data with an answer is a head MR image in which a tumor as a measurement target of MR spectroscopy is drawn. In this case, a label is assigned in such a manner as to indicate a tumor, and a drawn tumor indicates an answer. Examples of the trial data with an answer include an MR image in which an actual tumor obtained by MR-imaging a patient with tumor in his or her head, or an MR image in which a pseudo-tumor is drawn. The pseudo-tumor is assigned to a given position in a head region by performing image processing on an MR image in which a tumor has not been drawn. As image processing, generative adversarial network (GAN), a simple replacement technique of a pseudo-tumor region, or another image processing may be used. Hereinafter, in the case where a true tumor and a pseudo-tumor are not particularly distinguished from each other, the two will be generically referred to as “a tumor”.

After step SA1, by implementing the function of label assignment 12, the processing circuitry 1 assigns a label (assigned label) to trial data obtained in step SA1 (step SA2). Specifically, in step SA2, the processing circuitry 1 first causes the display device 5 to display the trial data (head MR image). In the head MR image to be displayed, a tumor is drawn. At this time, the processing circuitry 1 may perform displaying by image-recognizing a tumor and visually emphasizing the image-recognized tumor. The first user observes the displayed trial data and assigns an ROI mark in such a manner as to surround the tumor via the input interface 7. The ROI mark is assigned as an assigned label to the trial data.

After step SA2, by implementing the function of training calibration models 13, the processing circuitry 1 generates a calibration parameter based on a comparison between an answer and an assigned label (step SA3). For example, in step SA3, the processing circuitry 1 calculates as the calibration parameter a distance between the answer and a position indicated by the assigned label. Specifically, the processing circuitry 1 calculates as the calibration parameter a distance between a position of a tumor as the answer and an ROI mark as the assigned label. Furthermore, the processing circuitry 1 generates the ROI mark indicative of a tumor as a correct label through image processing, thereby calculating the distance between the correct label and the assigned label, as a calibration parameter. The distance may be defined in terms of scalar amount or a higher-order vector amount.

By repeating steps SA1 to SA3 with respect to various trial data pieces, a plurality of training samples each including trial data relating to the first user, an assigned label, and a calibration parameter are collected. The trial data and the assigned labels are collected as an input training sample, and the calibration parameter is collected as an output training sample.

After step SA3, by implementing the function of training calibration models 13, the processing circuitry 1 generates a calibration model based on the trial data, the assigned label, and the calibration parameter (step SA4). Specifically, the processing circuitry 1 trains a training parameter of the calibration model based on the input training sample including the trial data and the assigned label, and the output training sample including the calibration parameter. The assigned label may be input to the machine learning model, as image data indicative of an ROI mark, or as numerical value data indicative of coordinates in which the ROI mark is drawn or coordinates indicated by the ROI mark. The training parameter is, for example, a network parameter of a training target such as a weight or bias of the calibration model. A training method is not particularly limited as long as it is supervised learning in which trial data and an assigned label are used as the input training sample and a calibration parameter is used as the output training sample. In this case, the processing circuitry 1 is only required to iteratively update a training parameter in such a manner as to minimize the error between a predicted calibration parameter obtained by sequentially propagating trial data and an assigned label to a calibration model, and a calibration parameter serving as an output training sample. An optimization method is not particularly limited as long as the optimization is performed by any method such as a stochastic gradient descent method. Furthermore, training parameters may be updated either for each training sample, or for each set of a plurality of training samples. As a matter of course, in the case of using the aforementioned trial data, assigned label, and calibration parameter, training is not limited to supervised learning, and other training methods such as weak supervised learning, semi-supervised learning, and contrastive learning may be used.

Step SA4 enables generation of a calibration model that receives, as input, trial data and a label (assigned label) assigned by the first user to the trial data, and outputs a calibration parameter for correcting the assigned label to a correct label. That is, a calibration model for calibrating the individual characteristics relating to label assignment by the first user can be generated. The calibration model can be stored in the memory device 3 in such a manner that the calibration model is correlated with user identification information of the first user.

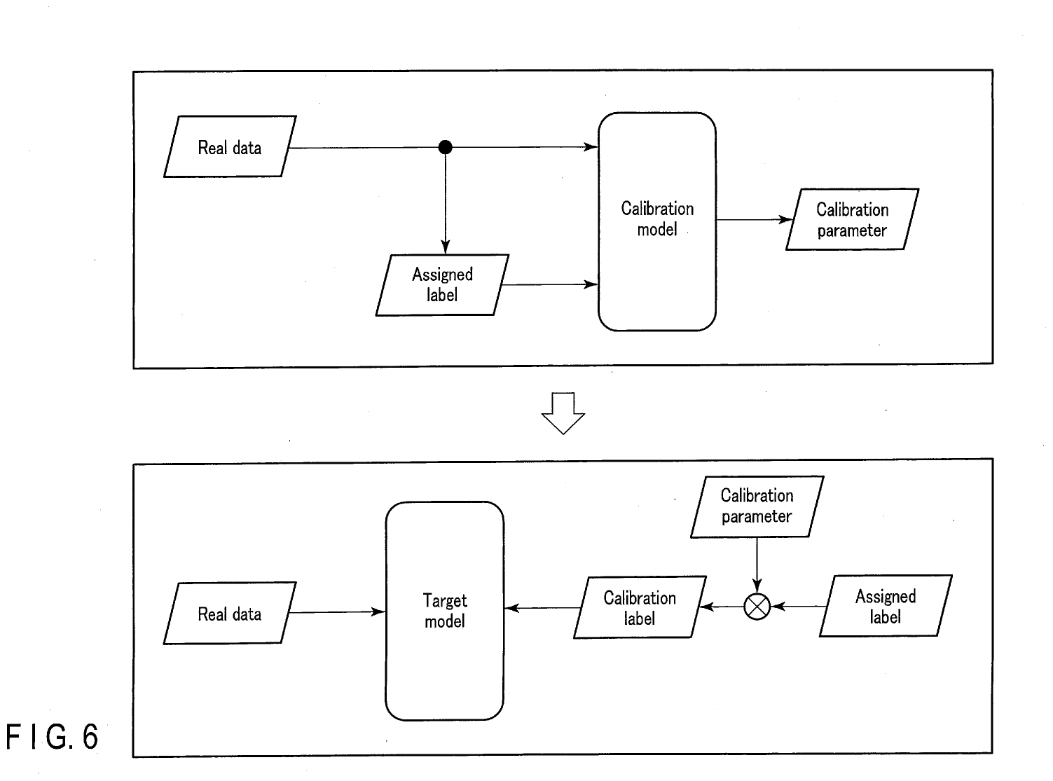

Next, a training process of a target model using the calibration model according to the first example will be described. FIG. 5 is a diagram showing a flow of an exemplary training process of a target model according to the first example. FIG. 6 is a diagram schematically showing a flow of an exemplary training process of a target model according to the first example.

As shown in FIG. 5 and FIG. 6, by implementing the obtainment function 11, the processing circuitry 1 obtains real data (step SB1). In the real data, it is assumed that a tumor targeted for label assignment is drawn. A tumor drawn in the real data is not necessarily recognized.

After step SB1, by implementing the function of label assignment 12, the processing circuitry 1 assigns a label to the real data obtained in step SB1 (step SB2). Specifically, in step SB2, the processing circuitry 1 first causes the display device 5 to display the real data. The first user observes the displayed real data and performs an operation of assigning an ROI mark indicative of a position of a tumor to the real data via the input interface 7. In accordance with the operation, the processing circuitry 1 assigns the ROI mark as an assigned label to the real data. It is assumed that the individual characteristics of the first user appear in the position of the assigned label.

After step SB2, by implementing the function of training target models 14, the processing circuitry 1 generates a calibration parameter by applying the real data obtained in step SB1 and the label assigned in step SB2 to the calibration model (step SB3). Specifically, the processing circuitry 1 searches the memory device 3 using identification information of the first user as a search key, thereby selecting a calibration model relating to the first user. Next, the processing circuitry 1 applies real data and an assigned label to the selected calibration model, thereby generating a calibration parameter for calibrating the individual characteristics of the first user relating to the aforementioned assigned label.

After step SB3, by implementing the function of training target models 14, the processing circuitry 1 generates a calibration parameter by applying the assigned label assigned in step SB3 to the calibration parameter generated in step SB3 (step SB4). By applying an assigned label to a calibration parameter, a label (calibration label) having the individual characteristics of the first user calibrated from the assigned label is generated. The calibration label indicates a correct position with respect to a tumor included in real data. That is, the calibration label is suppressed in terms of the individual characteristics of the first user and is expected to have the accuracy equivalent to that of the true correct label. Such a calibration label is considered of superior reliability to an assigned label.

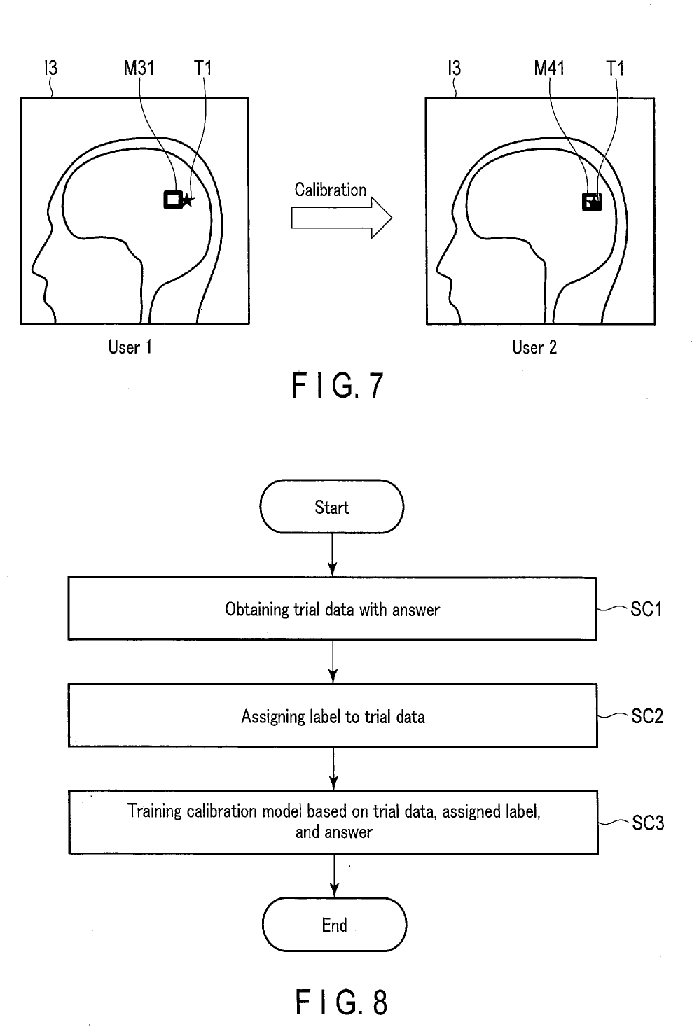

FIG. 7 is a diagram showing an exemplary positional relationship between an assigned label and a calibration label. As shown in FIG. 7, a tumor T1 is drawn in a head MR image I3 which is real data. In step SB2, a ROI mark (assigned label) M31 is assigned by the first user. In the first user, the label M31 is assigned in the left side of the image of the tumor T1. In step SB4, a calibration label M41 in which the individual characteristics of the first user which appear in the assigned label M31 are calibrated is generated using a calibration model for the first user. The calibration label M41 is assigned to an approximately center of the tumor T1. With the calibration model for the first user, the individual characteristics such as assignment of an image to the left side are suppressed. Accordingly, the calibration label 41 is assigned to a correct position, and is thus superior in accuracy and reliability to the assigned label M31.

By repeating steps SB1 to SB4 with respect to various real data pieces, a plurality of training samples each including real data and a calibration label relating to the first user are collected. The real data is obtained as an input training sample, and the calibration label is collected as an output training sample.

After step SB4, by implementing the function of training target models 14, the processing circuitry 1 trains a target model based on the real data obtained in step SB1 and the calibration label generated in step SB4 (step SB5). Specifically, the processing circuitry 1 trains training parameters of the target model based on the input training sample serving as the real data and the output training sample serving as the calibration label. A training method is not particularly limited as long as it is supervised learning in which real data is used as an input training sample and a calibration label is used as an output training sample. In this case, the processing circuitry 1 is only required to iteratively update a training parameter in such a manner as to minimize the error between a predicted label obtained by sequentially propagating real data to a calibration model, and a calibration label serving as an output training sample. An optimization method is not particularly limited as long as the optimization is performed by any method such as a stochastic gradient descent method. Furthermore, training parameters may be updated either for each training sample, or for each set of a plurality of training samples. As a matter of course, in the case of using the aforementioned real data and calibration label, training is not limited to supervised learning, and other training methods such as weak supervised learning, semi-supervised learning, and contrastive learning may be used.

According to step SB5, it becomes possible to input real data and generate a target model that outputs a label indicative of a tumor drawn in the real data. The target model is trained using a calibration label in which the individual characteristics relating to label assignment by the first user are calibrated. This renders it possible to perform the machine learning of a target model in which the influence of the individual characteristics in a label is suppressed. This also renders it possible to improve the accuracy of a target model.

### SECOND EXAMPLE

A calibration model according to a second embodiment is a machine learning model that receives, as input, input data and a label assigned to the input data, and outputs a calibration label. The calibration label is an example of calibration data output from the calibration model. By implementing the function of training calibration models 13, the processing circuitry 1 trains the calibration model based on calibration training data, a calibration training label assigned by a user to the calibration training data, and a correct label with respect to the calibration training data. A target model according to the second example is trained based on input data, an assigned label, and a calibration label. By implementing the function of training target models 14, the processing circuitry 1 generates a calibration label by applying a calibration model to target training data and a target training label, and trains a target model based on the target training data and the calibration label. First, a training method of the calibration model according to the second example will be described.

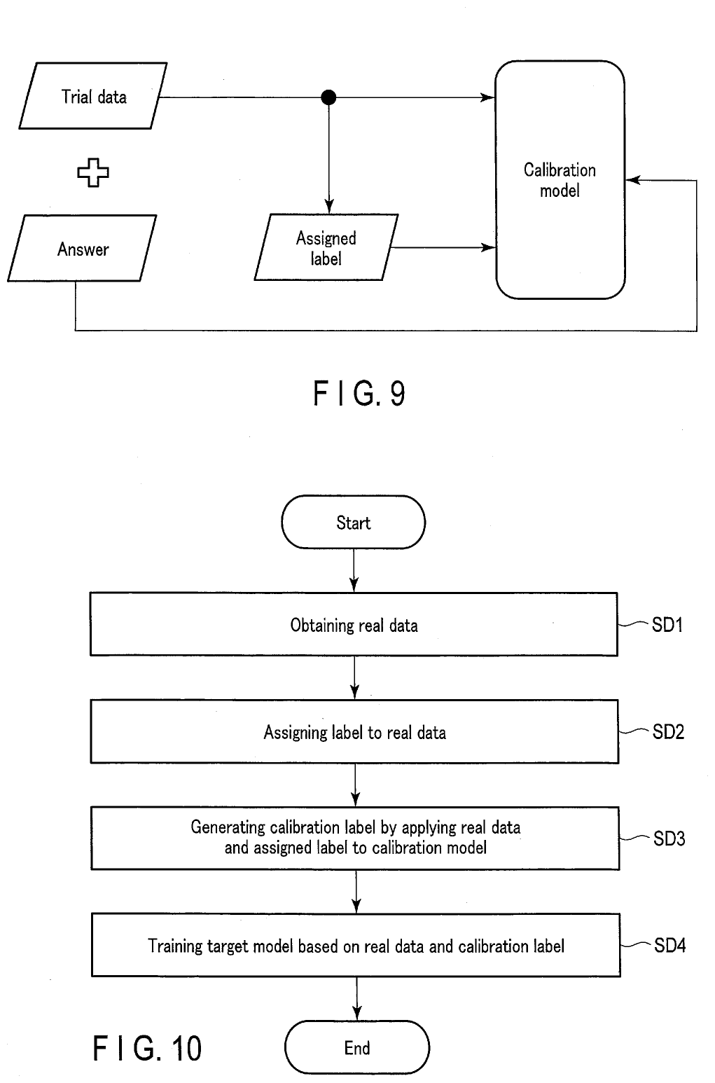

FIG. 8 is a diagram showing a flow of an exemplary training process of the calibration model according to the second example. FIG. 9 is a diagram schematically showing a flow of an exemplary training process of the calibration model according to the second example.

As shown in FIG. 8 and FIG. 9, by implementing the obtainment function 11, the processing circuitry 1 obtains trial data with an answer (step SC1). Step SC1 is similar to step SA1.

After step SC1, by implementing the function of label assignment 12, the processing circuitry 1 assigns a label (assigned label) to trial data obtained in step SC1 (step SC2). Step SC2 is similar to step SA2.

By repeating steps SC1 to SC2 with respect to various trial data pieces, a plurality of training samples each including trial data relating to the first user, an assigned label, and a correct label are collected. The correct label is a label generated based on an answer included in trial data with an answer. Specifically, the correct label is generated as an ROI mark indicative of a tumor drawn in an MR image serving as trial data. The trial data and the assigned label are obtained as an input training sample, and an answer is collected as an output training sample.

After step SC2, by implementing the function of training calibration models 13, the processing circuitry 1 generates a calibration model based on the trial data, the assigned label, and the answer (correct label) (step SC3). Specifically, the processing circuitry 1 trains a training parameter of the calibration based on the input training sample including trial data and assigned label, and the output training sample including a correct label. A training method is not particularly limited as long as it is supervised learning in which trial data and an assigned label are used as the input training sample and a correct label is used as the output training sample. In this case, the processing circuitry 1 is only required to iteratively update a training parameter in such a manner as to minimize the error between a predicted label, obtained by sequentially propagating trial data and an assigned label to a calibration model, and a correct label serving as an output training sample.

Step SC3 enables generation of a calibration model that receives, as input, trial data and a label (assigned label) assigned by the first user to the trial data, and outputs a correct label with respect to the trial data. That is, a calibration model for calibrating the individual characteristics relating to label assignment by the first user can be generated. The calibration model can be stored in the memory device 3 in such a manner that the calibration model is correlated with user identification information of the first user.

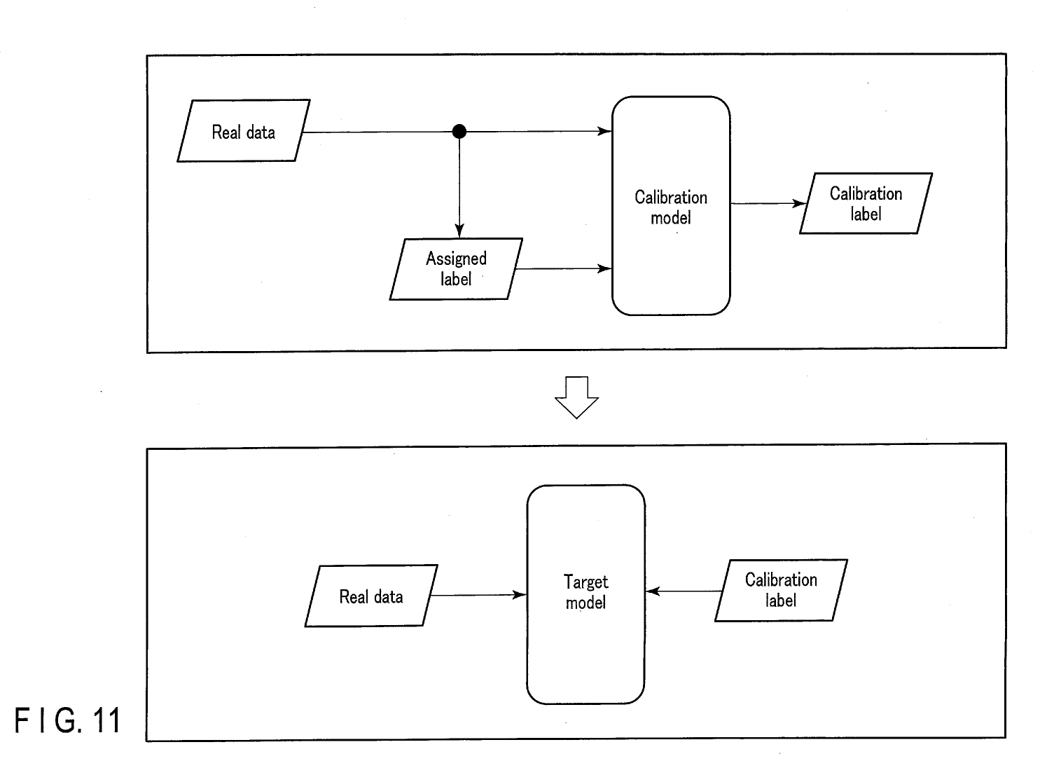

Next, a learning process of a target model using the calibration model according to the second example will be described. FIG. 10 is a diagram showing a flow of an exemplary training process of a target model according to the second example. FIG. 11 is a diagram schematically showing a flow of the exemplary training process of the target model according to the second example.

As shown in FIG. 10 and FIG. 11, by implementing the obtainment function 11, the processing circuitry 1 obtains real data (step SD1). Step SD1 is similar to step SB1.

After step SD1, by implementing the function of label assignment 12, the processing circuitry 1 assigns a label to the real data obtained in step SD1 (step SD2). Step SD2 is similar to step SB2.

After step SD2, by implementing the function of training target models 14, the processing circuitry 1 generates a calibration parameter by applying the real data obtained in step SD1 and the label assigned in step SD2 to the calibration model (step SD3). Specifically, the processing circuitry 1 searches the memory device 3 using identification information of the first user as a search key, thereby selecting a calibration model relating to the first user. Next, the processing circuitry 1 applies real data and an assigned label to the selected calibration model, thereby generating a label (calibration label) in which the individual characteristics of the first user relating to the aforementioned assigned label is calibrated.

By repeating steps SD1 to SD3 with respect to various real data pieces, a plurality of training samples each including real data and a calibration label relating to the first user are collected. The real data is collected as an input training sample, and the calibration label is obtained as an output training sample.

After step SD3, by implementing the function of training target models 14, the processing circuitry 1 trains a target model based on the real data obtained in step SD1 and the calibration label generated in step SD3 (step SD4). Step SD4 is similar to step SB5.

According to step SD4, it becomes possible to input real data and generate a target model that outputs a label indicative of a tumor drawn in the real data. The target model is trained using a calibration label in which the individual characteristics relating to label assignment by the first user are calibrated. This renders it possible to perform the machine learning of a target model in which the influence of the individual characteristics in a label is suppressed. This also renders it possible to improve the accuracy of a target model.

### THIRD EXAMPLE

A calibration model according to a third example is a machine learning model that receives, as input, input data and an assigned label assigned to the input data, and outputs a reliability of the assigned label. The reliability is an example of calibration data output from the calibration model. By implementing the function of training calibration models 13, the processing circuitry 1 determines a reliability of a calibration training label with respect to calibration training data, and trains a calibration model according to a third example based on the calibration training data and the calibration training label. A target model according to the third example is trained based on input data, an assigned label, and a reliability. By implementing the function of training target models 14, the processing circuitry 1 applies the calibration model according to the third example to target training data and a target training label, and outputs a reliability with respect to the target training data, thereby training a target model based on the target training data and the target training label. First, a training method of the calibration model according to the third example will be described.

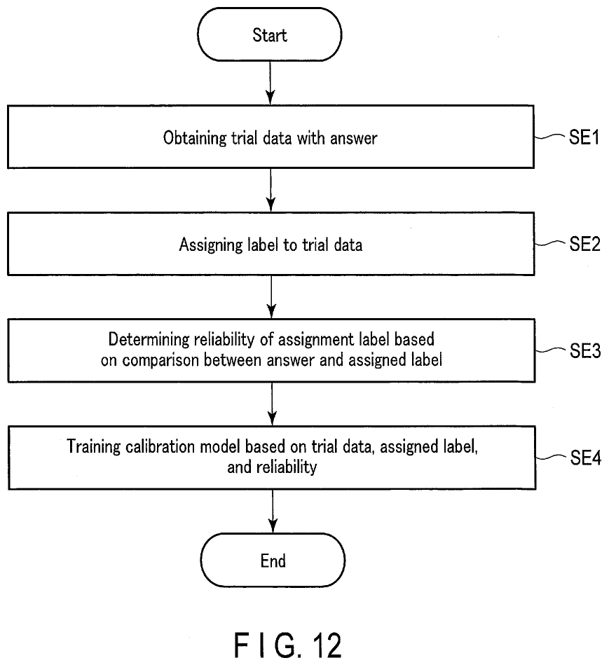

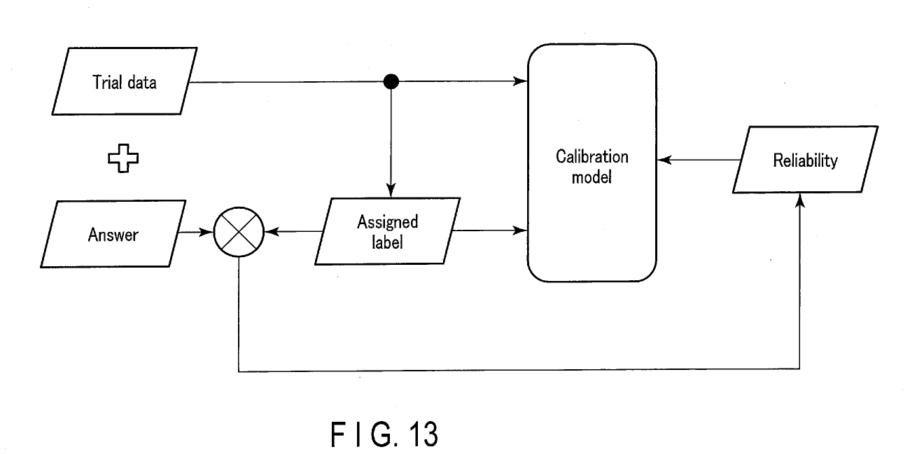

FIG. 12 is a diagram showing a flow of an exemplary training process of the calibration model according to the third example. FIG. 13 is a diagram schematically showing a flow of an exemplary training process of the calibration model according to the third example.

As shown in FIG. 12 and FIG. 13, by implementing the obtainment function 11, the processing circuitry 1 obtains trial data with an answer (step SE1). Step SE1 is similar to step SA1.

After step SE1, by implementing the function of label assignment 12, the processing circuitry 1 assigns a label (assigned label) to trial data obtained in step SE1 (step SE2). Step SE2 is similar to step SA2.

After step SE2, by implementing the function of training calibration models 13, the processing circuitry 1 generates a reliability of a label assigned in step SE2, based on a comparison between an answer included in trial data and the assigned label (step SE3). The reliability is an index obtained by quantifying a reliability of the assigned label with respect to the input data. Various methods can be adopted as a method of determining a reliability. For example, the processing circuitry 1 calculates, as a reliability, a distance between an assigned label and a correct label. The correct label is a label generated based on an answer included in trial data. Specifically, the processing circuitry 1 calculates, as a reliability, a distance between a position indicated by an ROI mark serving as an assigned label and a position indicated by an ROI mark serving as a correct label. The reliability may be a numeric value of a distance itself, the numeric value of the distance scaled into a predetermined value range, or a category classified according to the numeric value of the distance. The reliability may be determined to be a numerical value designated by the first user, etc., via the input interface 7. As an example, the reliability described in the following is a numeric value scaled into a range between 0 and 1.

By repeating steps SE1 to SE3 with respect to various trial data pieces, a plurality of training samples each including trial data relating to the first user, an assigned label, and a reliability are collected. The trial data and the assigned label are collected as an input training sample, and a reliability is collected as an output training sample.

After step SE3, by implementing the function of training calibration models 13, the processing circuitry 1 generates a calibration model based on the trial data, the assigned label, and the reliability (step SE4). Specifically, the processing circuitry 1 trains a training parameter of the calibration model based on an input training sample including the trial data and the assigned label, and an output training sample including a reliability. A training method is not particularly limited as long as it is supervised learning in which trial data and an assigned label are used as the input training sample and a reliability is used as the output training sample. In this case, the processing circuitry 1 is only required to iteratively update a training parameter in such a manner as to minimize the error between a predicted reliability obtained by sequentially propagating trial data and an assigned label to a calibration model, and a reliability serving as an output training sample. An optimization method is not particularly limited as long as the optimization is performed by any method such as a stochastic gradient descent method. Furthermore, training parameters may be updated either for each training sample, or for each set of a plurality of training samples. As a matter of course, in the case of using the aforementioned trial data, assigned label, and reliability, training is not limited to supervised learning, and other training methods such as weak supervised learning, and semi-supervised learning may be used.

Step SE4 enables generation of a calibration model that receives, as input, trial data and a label (assigned label) assigned by the first user to the trial data and outputs a reliability of the assigned label. That is, a calibration model for calibrating the individual characteristics relating to label assignment by the first user can be generated. The calibration model can be stored in the memory device 3 in such a manner that the calibration model is correlated with user identification information of the first user.

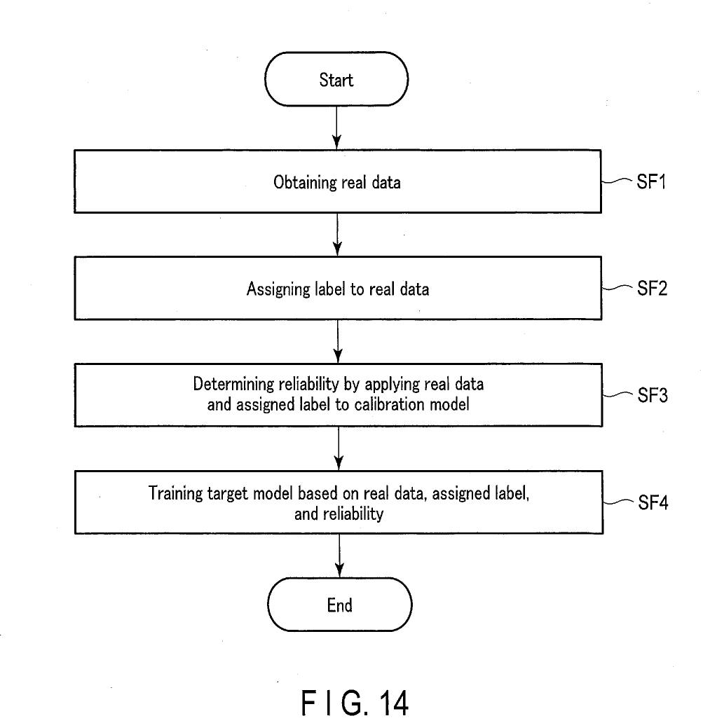

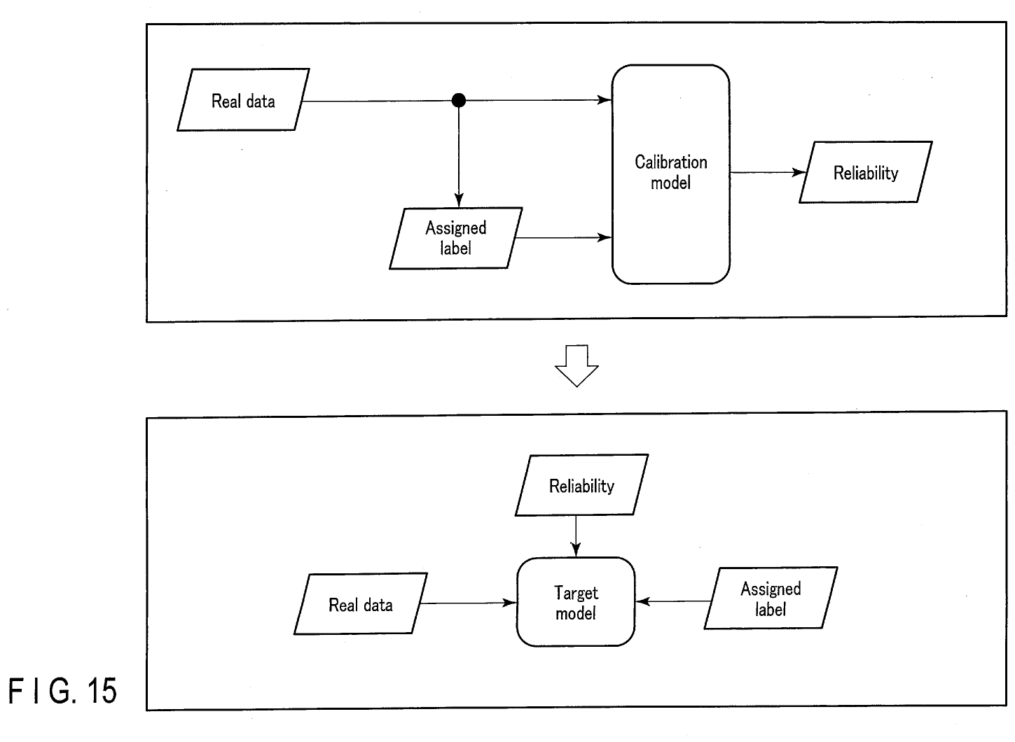

Next, a learning process of a target model using the calibration model according to the third example will be described. FIG. 14 is a diagram showing a flow of an exemplary training process of the target model according to the third example. FIG. 15 is a diagram schematically showing a flow of the exemplary training process of the target model according to the third example.

As shown in FIG. 14 and FIG. 15, by implementing the obtainment function 11, the processing circuitry 1 obtains real data (step SF1). Step SF1 is similar to step SB1.

After step SF1, by implementing the function of label assignment 12, the processing circuitry 1 assigns a label to the real data obtained in step SF1 (step SF2). Step SF2 is similar to step SB2.

After step SF2, by implementing the function of training target models 14, the processing circuitry 1 determines a reliability by applying the real data obtained in step SF1 and the label assigned in step SF2 to the calibration model (step SF3). Specifically, the processing circuitry 1 searches the memory device 3 using identification information of the first user as a search key, thereby selecting a calibration model relating to the first user. Next, the processing circuitry 1 applies real data and an assigned label to the selected calibration model, thereby determining a reliability of the assigned label.

By repeating steps SF1 to SF3 with respect to various real data pieces, a plurality of training samples each including trial data relating to the first user, an assigned label, and a reliability are collected. The real data, the assigned label, and the reliability are respectively collected as an input training sample, an output training sample, and a parameter of a loss function.

After step SF3, by implementing the function of training target models 14, the processing circuitry 1 trains a target model based on the real data obtained in step SF1, the calibration label assigned in step SF2, and the reliability determined in step SF3 (step SF4). In step SF4, the processing circuitry 1 trains a training parameter of the target model based on the real data serving as an input training sample and the real data serving as an input training sample. A training method is not particularly limited as long as real data and a calibration label are used, and a training method such as supervised learning, weak supervised learning, semi-supervised learning, and contrastive learning may be used. As an example, a training method described in the following is supervised learning.

In this case, the processing circuitry 1 executes supervised learning in which real data is used as an input training sample and an assigned label is used as an output training sample. In the supervised learning, the processing circuitry 1 iteratively updates a training parameter in such a manner as to minimize an error between a predicted label, obtained by sequentially propagating real data to a target model, and an assigned label serving as an output training sample. An optimization method is not particularly limited as long as the optimization is performed by any method such as a stochastic gradient descent method.

Herein, an error Lᵢ between a predicted label yᵢ and an assigned label tᵢ is expressed by, for example, the following equation (1): In the following, “i” is a number assigned to a training sample. The equation (1) expresses the error Lᵢ by least squares as a task of the target model according to the present embodiment takes the form of regression. However, a given function such as cross entropy may be used depending on the task of the target model. As shown in the following equation (2), the predicted label yᵢ is expressed by a function f (W, xᵢ) expressing a conversion from input to output using the target model. W is a set of training parameters of the target model, and xᵢ expresses real data (input training sample). The processing circuitry 1 updates a training parameter W in such a manner as to minimize a loss function L shown in the following equation (3). The loss function L is expressed by a total sum of a product of the error Lᵢ up to the input training sample i=1−N (integer) and a reliability cᵢ. The reliability cᵢ is a parameter of the loss function L, expressing the reliability corresponding to the input training sample xᵢ.

Lᵢ=| |tᵢ−yᵢ| |² (1)

yᵢ=f(W,xᵢ) (2)

L=Σᵢ₌₁^{N}(cᵢ·Lᵢ) (3)

As shown in the above equations (1) to (3), the reliability cᵢ of the training sample “i” functions as a weight with respect to the error Lᵢ. In the case of the reliability cᵢ being relatively small, the training sample “i” does not relatively contribute to machine learning. In the case of the reliability cᵢ being relatively small, the training sample “i” relatively contributes to machine learning. Applying the reliability cᵢ to the error Lᵢ enables machine learning to be performed on a target model in which the influence of the individual characteristics in a label is suppressed. This also renders it possible to improve the accuracy of the target model.

The description of the first to third examples is completed. The first to third examples enable training of a target model while calibrating the individual characteristics which appear in a label assigned by a user. As described in the above, a bias and a variation are considered as types of the individual characteristics. Whether a calibration model is configured to calibrate a bias or a variation depends on a type of the individual characteristics that appear in a label used for training of the calibration model. That is, in the case where the first user assigns labels with a fixed bias without a variation in step SA2, it becomes possible that the calibration model calibrates a bias specific to the first user. On the other hand, in the case where the first user assigns labels with a fixed variation without a bias in step SA2, it becomes possible that the calibration model calibrates a variation specific to the first user. As a matter of course, in the case where the first user assigns labels with a fixed bias and a fixed variation in step SA2, it becomes possible that the calibration model calibrates a bias and a variation each specific to the first user.

The training method of the above calibration is one example, and other training methods may be used. As an example, the calibration model may be generated using transfer learning. In such a case, by implementing the function of training calibration models 13, the processing circuitry 1 first trains a calibration model targeted for a user other than the first user (for example, a second user) in accordance with one of the examples described in the above. The processing circuitry 1 copies training parameters of the trained calibration model corresponding to the second user to an untrained calibration model. The processing circuitry 1 trains the calibration model targeted for the first user by training the training parameters of the untrained calibration model in such a manner that calibration training data and a calibration training label are input and calibration data is output. According to this transfer learning, training parameters of a trained calibration model for other people are set to initial parameters of an untrained calibration model corresponding to the first user, so that the latter model can be easily trained.

### FIRST APPLICATION EXAMPLE

The first to third examples described in the above focus on calibration of the individual characteristics in label assignment by a single user. The apparatus of machine learning 100 may perform calibration of the individual characteristics in label assignment by a plurality of users. Hereinafter, operation examples of the apparatus of machine learning 100 according to application examples will be described. In the following explanation, structural elements having substantially the same functions as in the above-described embodiments will be denoted by the same reference symbols, and a repetitive description will be given only where necessary.

The processing circuitry 1 according to the first application example trains, by implementing the function of training target models 14, a target model based on a combination of target training data relating to a first user, a target training label, and a calibration model, and a combination of target training data relating to a second user, a target training label, and a calibration model. The second user is another person who has different individual characteristics from those of the first user. The second user is a generic term for a person other than the first user, does not necessarily indicate a single person, and may indicate multiple people with differing individual characteristics.

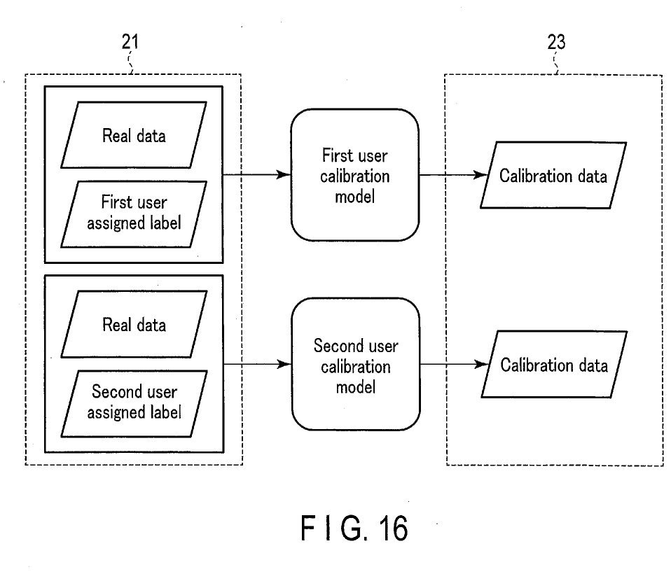

FIG. 16 is a diagram schematically showing an exemplary process performed by the apparatus of machine learning 100 according to a first application example. As shown in FIG. 16, a calibration model for the first user and a calibration model for the second user are generated by implementing the function of training calibration models 13. The calibration model for the first user and the calibration model for the second user may be of any one of the types in the first to third embodiments as long as they are of the same type. The processing circuitry 1 generates, by using the calibration model for the first user, calibration data 23 relating to calibration of label assignment by the first user from real data and an assigned label 21 assigned by the first user. Similarly, the processing circuitry 1 generates, by using the calibration model for the second user, the calibration data 23 from real data and the assigned label 21 assigned by the second user.

A form of the calibration data 23 depends on the type of calibration model. In the case of the calibration model according to the first example, the calibration data 23 includes a label assigned by the first user to real data, a calibration parameter output from the calibration model, and a calibration label in which the assigned label is calibrated using the calibration parameter. In the case of the calibration model according to the second example, the calibration data 23 includes a label assigned by the first user to real data and a calibration parameter output from the calibration model. In the case of the calibration model according to the third example, the calibration data 23 includes a label assigned by the first user to real data and a reliability output from the calibration model.

The memory device 3 stores a plurality of calibration models respectively corresponding to a plurality of users. Each of the calibration models is associated with corresponding user identification information. It is preferable that the calibration models be systematically stored in such a manner that they can be retrieved using user identification information. The memory device 3 may store, as a calibration model, a neural network assigned a trained training parameter, or a trained parameter only. When using a calibration model, the processing circuitry 1 reads user identification information correlated with an assigned label to be processed, and selects and reads a calibration model associated with the read user identification information from among a plurality of calibration models stored in the memory device 3. For example, in the case where an assigned label to be processed is associated with user identification information of the first user, a calibration model for the first user is selected and read out.

A plurality of calibration data 23 pieces is collected by the first user and the second user. In the case of a calibration model being of the type in the first example or the second example, a calibration label in which the individual characteristics of the first user are calibrated is obtained as the calibration data 23 by using a first user calibration model, and a calibration label in which the individual characteristics of the second user are calibrated is obtained as the calibration data 23 by using a second user calibration model. That is, the calibration data 23 suppressed in individual difference can be obtained. In the case of a calibration model being of the type in the third example, a label assigned by the first user and a reliability of the label are obtained as the calibration data 23 by using the first user calibration model, and a label assigned by the second user and a reliability of the label are obtained as the calibration data 23 by using the second user calibration model. These calibration data 23 pieces are also stored in the memory device 3.

The processing circuitry 1 trains a target model based on the real data 21 and the calibration data 23 by implementing the function of training target models 14. The target model is trained in accordance with the methods described in the first to third examples, depending on the type of calibration model. At this time, since the individual characteristics of the first user are suppressed from the calibration data 23 relating to the first user and obtained by the first user calibration model, and the individual characteristics of the second user are suppressed from the calibration data relating to the second user and obtained by the second user calibration model, utilization of these calibration data 23 pieces enables machine learning with high accuracy, calibrated in individual characteristics of each user to be performed on a target model.

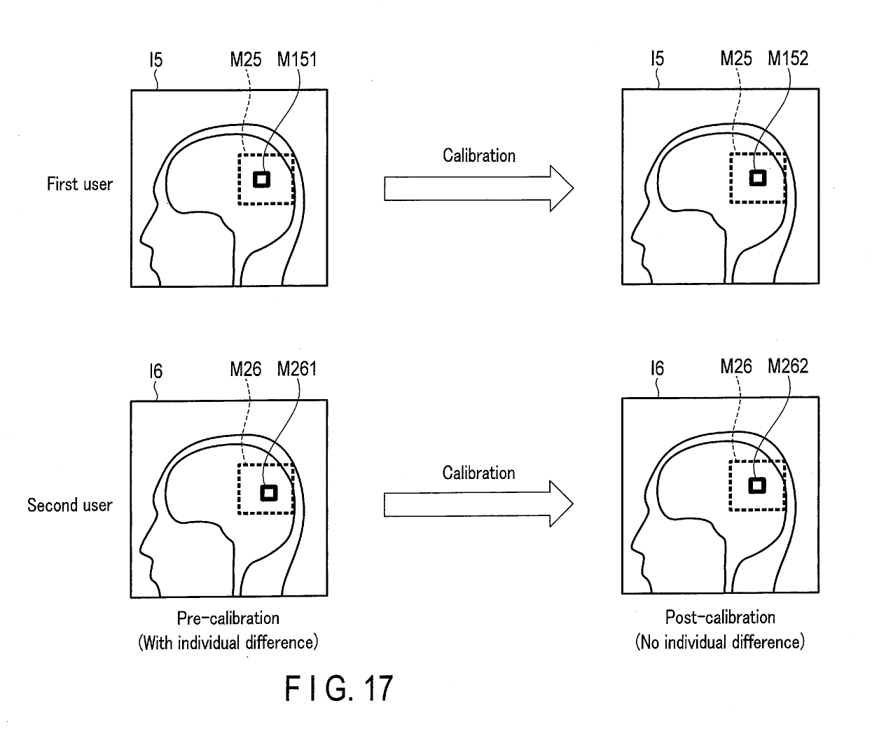

FIG. 17 is a diagram showing a calibration example of the individual characteristics in label assignment by the first user and the second user. As shown in FIG. 17, the first user assigns, as an assigned label, an ROI mark M151 indicative of a position of a voxel of interest into an ROI mark M25 of a local shimming of a head MR image I5. The calibration model for the first user cancels a habit in label assignment by the first user, so that the ROI mark M151 is shifted to an ROI mark M152. Similarly, the second user assigns, as an assigned label, an ROI mark M261 indicative of a position of a voxel of interest into an ROI mark M26 of local shimming for a head MR image I65. The calibration model for the second user cancels a habit in label assignment by the second user, so that the ROI mark M261 is shifted to an ROI mark M262. Individual differences relating to label assignment for the ROI mark M152 and the ROI mark M262 are expected to be suppressed.

### SECOND APPLICATION EXAMPLE

The first application example focuses on the individual characteristics in label assignment by each user. However, even labels assigned by the same user may vary in accuracy under different label assignment conditions. It is assumed that label assignment conditions include a type of an application for use in label assignment, an assignment processing step, etc. The second application example focuses on the label assignment condition.

The processing circuitry 1 according to the second application example trains, by implementing the function of training target models 14, a target model based on a combination of target training data relating to a first assignment condition, a target training label, and a calibration model, and a combination of target training data relating to a second assignment condition, a target training label, and a calibration model. It is assumed that both the target training label relating to the first assignment condition and the target training label relating to the second assignment condition are assigned by the first user. A calibration model relating to the first assignment condition is a calibration model for calibrating the individual characteristics in label assignment by the first user under the first assignment condition. A calibration model relating to the second assignment condition is a calibration model for calibrating the individual characteristics in label assignment by the first user under the second assignment condition. The first assignment condition and the second assignment condition indicate assignment conditions with different condition values. The condition value indicates a type of application for use in label assignment or a specific content of an assignment processing step. The type of application indicates a company that manufactures a specific application, an application version, etc. For example, as an application for label assignment, so-called “MRI simulator software” which predicts MR imaging by a magnetic resonance imaging apparatus or behavior of various devices, may be used. Software that predicts MR imaging is also called a Bloch simulator. MRI simulators are sold by multiple companies. Product types of MRI simulators by different companies correspond to types of application. The assignment processing step indicates a processing order of steps up to label assignment in the use of a specific application, a set value of an application, etc. The individual characteristics according to the second application example encompass variations in label assignment by the same user between the different assignment conditions.

The processing circuitry 1 according to the second application example trains, by implementing the function of training calibration models 13, a calibration model relating to the first assignment condition by any of the methods in the first to third examples using a label assigned by the first user under the first label assignment condition. Furthermore, the processing circuitry 1 according to the second application example trains, by implementing the function of training calibration models 13, a calibration model relating to the second assignment condition by any of the methods in the first to third examples using a label assigned by the first user under the second label assignment condition. The calibration model relating to the first assignment condition and the calibration model relating to the second assignment condition are stored in the memory device 3. The calibration model is stored in such a manner as to be correlated with identification information of a label assignment condition.

The processing circuitry 1 according to the second application example assigns, by implementing the function of training target models 14, a target training label to target training data under a specific label assignment condition. The processing circuitry 1 reads assignment condition identification information relating to the label assignment condition, and selects and reads a calibration model correlated with the read assignment condition identification information from a plurality of calibration models stored in the memory device 3. For example, in the case of assigning a target training label under the second assignment condition, the processing circuitry 1 selects and reads a calibration model correlated with assignment condition identification information of the second label assignment condition. Next, the processing circuitry 1 trains a target model while calibrating the target training label by using the read calibration model. As described in the above, the target model is trained depending on the type of calibration model.

According to the second application example, as described in the above, a target model can be trained using a label in which the individual characteristics caused by a difference in label assignment condition are calibrated, thereby improving label reliability and resulting in the improved target model reliability. Furthermore, since a target model is trained using a label in which the individual characteristics caused by a difference in label assignment condition are calibrated, improved target model reliability is expected.

In the second application example, label assignment conditions for use in assignment of a label to calibration training data and assignment of a label to target training data are preferably coordinated. Specifically, label assignment on trial data and label assignment on real data are coordinated in terms of the type of application or the assignment processing step. Coordination between label assignment conditions enables machine learning of a target model to be further improved in accuracy.

The second application example and the first application example may be combined. That is, a calibration model may be generated for each user and for each label assignment condition. In this case, the calibration model is stored in the memory device 3 in such a manner as to be correlated with user identification information and assignment condition identification information of a label assignment condition. In the use of a calibration model, the processing circuitry 1 reads user identification information and assignment condition identification information, both correlated with an assigned label, to be processed, and selects and reads a calibration model correlated with a combination of the read user identification information and assignment condition identification information from a plurality of calibration models stored in the memory device 3. For example, in the case of an assigned label to be processed being correlated with user identification information of the first user and assignment condition identification information of the first label assignment condition, a calibration model corresponding to a combination of the first user and the first label assignment condition is to be selected and read.

### THIRD APPLICATION EXAMPLE

A neural network that integrates a plurality of calibration models relating to a plurality of users, obtained in the above various examples, may be used as a calibration model. Hereinafter, a neural network that integrates a plurality of calibration models relating to a plurality of users will be referred to as a “blend network”.

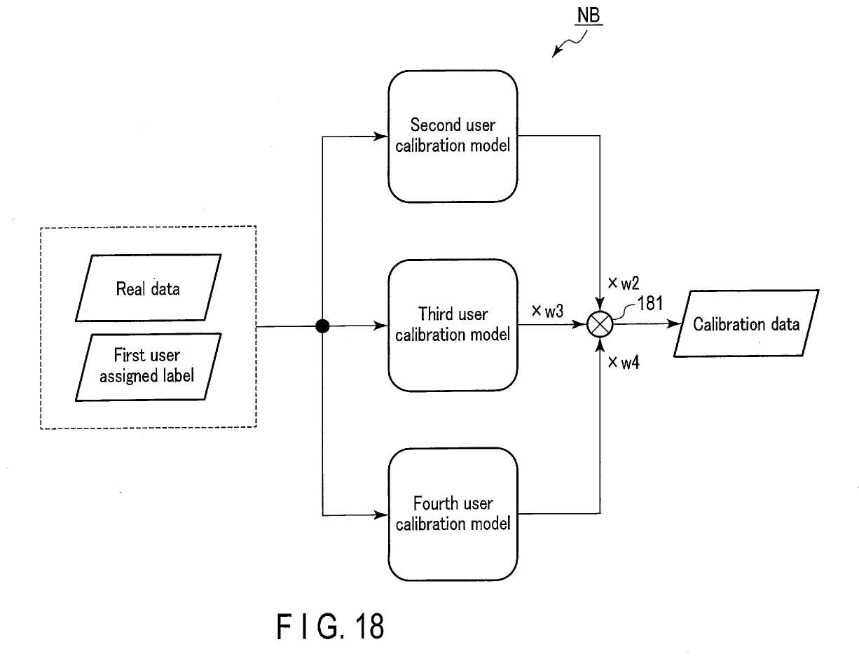

FIG. 18 is a diagram showing a configuration example of a blend network NB according to a third application example. FIG. 18 assumes that a calibration target of the blend network NB is a first user. The blend network NB has a plurality of calibration models respectively corresponding to a plurality of users other than the first user, and an addition layer 181 that weight-adds a plurality of calibration data pieces from the calibration models in accordance with a weight trained for calibration of label assignment by the first user, and outputs calibration data relating to calibration of label assignment by the first user. The blend network NB functions as a calibration model configured to calibrate label assignment by the first user.

The number of other users may be any number greater than or equal to two. The following description assumes that the number of other users is three, including a second user, a third user, and a fourth user. A second user calibration model is a calibration model targeted for the second user in the above various examples, and is configured to receive real data and an assigned label as input and to output calibration data relating to calibration of the individual characteristics in label assignment by the second user. A third user calibration model is a calibration model targeted for the third user in the above various examples, and is configured to receive real data and an assigned label as input and to output calibration data relating to calibration of the individual characteristics in label assignment by the third user. A fourth user calibration model is a calibration model targeted for the fourth user in the above various examples, and is configured to receive real data and an assigned label as input and to output calibration data relating to calibration of the individual characteristics in label assignment by the fourth user.

The addition layer 181 executes weight-adding on the calibration data from the second user calibration model, the calibration data from the third user calibration model, and the calibration data from the fourth user calibration model, thereby outputting ultimate calibration data for a first user. Specifically, the addition layer 181 generates weighted calibration data by multiplying the calibration data from the second user calibration model by a weight w2, generates weighted calibration data by multiplying the calibration data from the third user calibration model by a weight w3, generates weighted calibration data by multiplying the calibration data from the fourth user calibration model by a weight w4, adding the weighted calibration data relating to the second user, the weighted calibration data relating to the third data, and the weighted calibration data relating to the fourth data, and thus generates ultimate calibration data. Hereinafter, this weight will be referred to as an “output weight”.

The output weights w2, w3, and w4 are determined through training of the blend network NB. The output weights w2, w3, and w4 are trained in such a manner as to calibrate the individual characteristics in label assignment by the first user who differs from a user for which each calibration model included in the blend network NB has been trained. Calibration data of the individual characteristics in label assignment by the fourth user is output from the blend network NB by inputting real data and a label assigned by the fourth layer to the real data to a calibration model relating to the first user, a calibration model relating to the second user, and a calibration model relating to the third user all included in the blend network NB.

Herein, training of the blend network NB will be described in detail. First, the second user calibration model, the third user calibration model, and the fourth user calibration model are individually trained in accordance with any one of the above examples. Next, an untrained blend network NB in which the addition layer 181 is installed is designed in an output destination for each of the second user calibration model, the third user calibration model, and the fourth user calibration model. Initial values of the output weights w2, w3, and w4 may be set to any number.

The output weights w2, w3, and w4 are trained based on supervised learning in which trial data and a label assigned by the first user to the trial data are input to the untrained blend network NB, and calibration data relating to calibration of the individual characteristics in label assignment by the first user is output. In the training of the blend network NB, training parameters of the second user calibration model, the third user calibration model, and the fourth user calibration model all included in the blend network NB are preferably fixed. A portion, or all, of the training parameters of the second user calibration model, the third user calibration model, and the fourth user calibration model may be trained together with the output weights w2, w3, and w4.

Training output weights of the blend network NB that integrates a plurality of calibration models enables a calibration model for calibrating the individual characteristics in label assignment by another user to be generated. Since the number of output weights is smaller than training parameters, a calibration model can be easily trained.

For a user other than the first user (for example, a fifth user, etc.), the output weights w2, w3, and w4 of the blend network NB that calibrates the individual characteristics in label assigned by such a user can be trained as with the case of the first user. The blend network NB assigned the trained output weights w2, w3, and w4 is stored in the memory device 23 in such a manner as to be correlated with user identification information. A combination of the output weights w2, w3, and w4 may be stored in the memory device 23 in such a manner as to be correlated with user identification information.

### OTHER TASK EXAMPLES

The above examples described the example in which the setting of a measurement voxel of MR spectroscopy is a task of a target model. However, as described in the above, a task of the target model according to the present embodiment is not limited to such setting. Hereinafter, some of the other specific examples of the task of the target model will be described.

A task of a target model according to a first specific example is detection of an imaging slice. The target model according to the first specific example is configured to receive, as input, a medical image in which an imaging target region is drawn, and to detect an imaging slice from the imaging target region. In machine learning, training parameters are trained in such a manner as to receive a medical image as input and to output an imaging slicing position. In collection of training data, labels which each correspond to the imaging slicing position are assigned by various users.

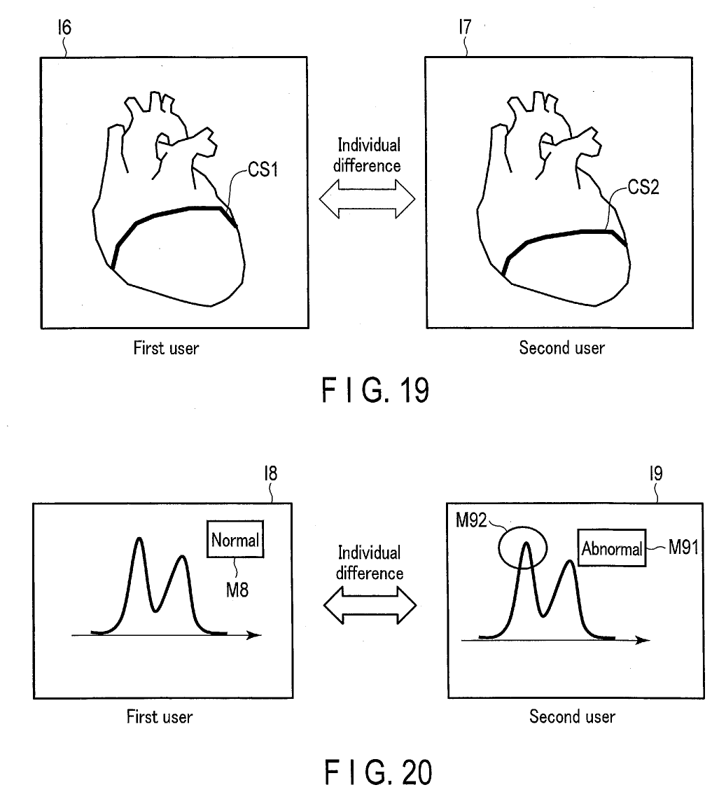

FIG. 19 is a diagram showing an example of individual characteristics in label assignment by the first user and the second user, according to a task for estimation of imaging slice. As shown in FIG. 19, by referring to a corresponding one of medical images I6 and I7 displayed on the display device 5, etc., each user assigns, as an assigned label, an imaging slice mark CS indicative of an imaging slice to an imaging target region drawn in the corresponding one of the medical images I6 and I7. The imaging target region is not particularly limited and may be any human body region such as a heart, a head, an abdomen, etc. FIG. 19 shows the example in which the imaging target region is a heart. Furthermore, a medical image diagnosis apparatus configured to perform imaging is also not particularly limited in terms of its type, and may be of any type such as a magnetic resonance imaging apparatus, an X-ray computed tomography apparatus, etc.

Each user observes a medical image in which an imaging target area is drawn, and specifies an imaging target such as a lesion, etc. Each user sets, via the input interface 7, a mark corresponding to an imaging slice (hereinafter, referred to as an “imaging slice mark”) to a medical image in such a manner as to include the imaging target. The imaging slice mark is set as an assigned label. The medical image is an example of trial data in the first to third examples described in the above. That is, the trial data may be an image obtained through medical imaging on an actual patient or may be an image obtained through medical imaging on a phantom. The imaging target such as a lesion, etc. may be actually included in a patient or a phantom, or may be artificially generated through an imaging process such as a GAN, etc.

Specifically, as shown in FIG. 19, the first user observes the medical image I6 to specify an imaging target in a heat region, thereby assigning the imaging slice mark CS1 as the assigned label to the imaging target. Similarly, the second user observes the medical image I7 to specify an imaging target in a heat region, thereby assigning the imaging slice mark CS2 as the assigned label to the imaging target. Determination of an imaging target and assignment of the imaging slice mark CS1 or CS2 depend on individual skills. Therefore, even though heart regions are anatomically the same region, positions of the imaging slice marks CS1 and CS2 reflect individual characteristics of respective users.

As described in the above, the task for estimation of imaging slice may cause an individual difference in accuracy of assigned labels (the imaging slice marks CS1 and CS2). Thus, it is useful for machine learning of a target model to calibrate individual characteristics in assigned label by using a calibration model described as an example in each of the first to third examples.

The first specific example described the task for estimation of imaging slice as a task of a target model. However, in the present embodiment, an application purpose of a cross section (slice) is not particularly limited as long as the task is to detect the slice. Not only the imaging slice but also a displayed cross section for post-processing on a medical image is considered as an application purpose. In such a case also, a medical image is not particularly limited in terms of its type, and may be generated by any medical image diagnosis apparatus such as a magnetic resonance imaging apparatus, an X-ray computed tomography apparatus, etc.

A task of a target model according to a second specific example is to judge the abnormality/normality. The target model according to the second specific example is configured to receive, as input, a spectrum of a measurement target and judge the abnormality or normality of that measurement target from the spectrum. In machine learning, training parameters are trained in such a manner as to receive a spectrum as input and to output a classification of abnormality or normality. A typical spectrum is series data of a given component of a measurement obtained by various types of measurement on a measurement target sample. A measurement method may be a method using an optical, magnetic, chemical, or immunological method with respect to a biological sample, or a method using various image analyses with respect to pixels or voxels of a medical image or an optical image. In collection of training data, labels each corresponding to an abnormality or normality judgment result are assigned by various users.

FIG. 20 is a diagram showing an example of individual characteristics in label assignment by the first user and the second user, according to a task of abnormality detection. As shown in FIG. 20, by referring to a spectrum, each user assigns an abnormality label or normality label as the assigned label. The example shown in FIG. 20 shows a spectrum as a frequency distribution of MR signal intensity measured by MR spectroscopy.

Each user observes a spectrum to judge abnormality or normality. In the case of judging abnormality, each user assigns a mark indicative of the abnormality (hereinafter referred to as an “abnormality mark”) to the spectrum via the input interface 7. In the case where no abnormality is judged, each user assigns a mark indicative of the normality (hereinafter referred to as a “normality mark”) to the spectrum via the input interface 7. The spectrum is an example of trial data in the first to third examples described in the above. That is, the trial data may be a spectrum obtained by performing MR spectroscopy on an actual patient, or a spectrum obtained by performing MR spectroscopy on a phantom. The imaging target such as a lesion, etc. may be actually included in a patient or a phantom or may be artificially generated through an imaging process such as a GAN, etc.

Specifically, as shown in FIG. 20, since the first user has determined the absence of abnormality through observation of a spectrum I8, he or she assigns a normality mark M8 to the spectrum I8 as a stamp of text “normal”. Since the second user has judged the presence of abnormality through observation of a spectrum I9, he or she assigns an abnormality mark M9 to the spectrum I9. Specific examples of an abnormality mark M9 may include an abnormality mark M91, which is a stamp of text “abnormal”, and a mark M92 indicative of a support area for the abnormality. Judgment of the abnormality or normality and determination of a support area for abnormality depend on individual skills. Therefore, even though spectra are the same, the presence/absence and/or positions of the normality mark M8 and the abnormality mark M9 reflect individual characteristics by respective users.

As described in the above, the task of abnormality detection may cause an individual difference in accuracy of assigned labels (the normality mark M8 and the abnormality mark M9). Thus, it is useful for machine learning of a target model to calibrate individual characteristics in assigned label by using a calibration model described as an example in each of the first to third examples, etc.

### (Inference Apparatus)

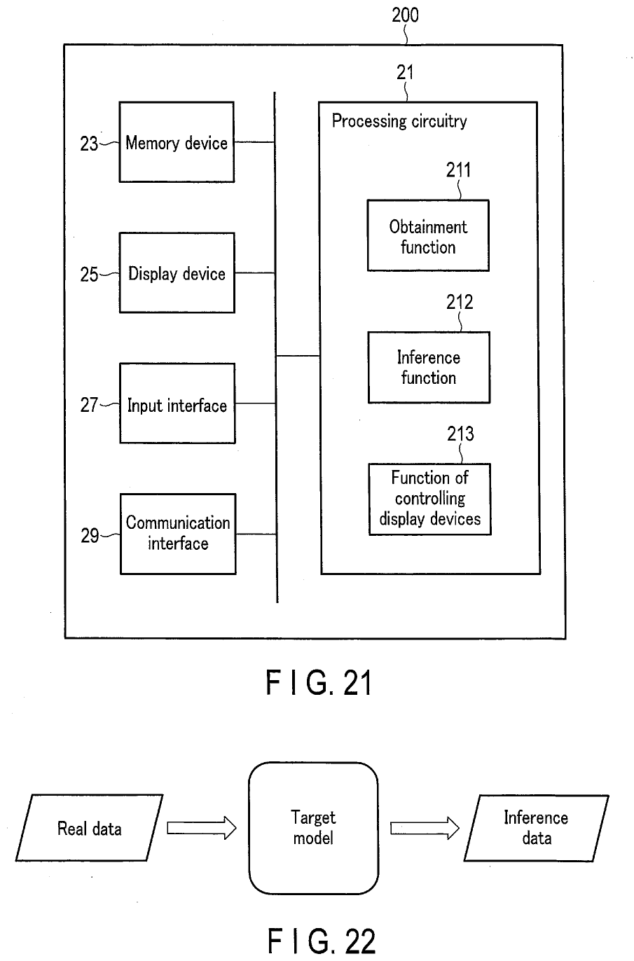

FIG. 21 is a diagram showing a configuration example of an inference apparatus 200 according to the present embodiment. As shown in FIG. 21, the inference apparatus 200 includes processing circuitry 21, the memory device 23, a display device 25, an input interface 27, and a communication interface 29. The processing circuitry 21, the memory device 23, the display device 25, the input interface 27, and the communication interface 29 perform data communications with each other via a bus.

The processing circuitry 21 includes a processor such as a CPU. The processor activates various programs installed in the memory device 23, etc., thereby implementing an obtainment function 211, an inference function 212, a function of controlling display devices 213, etc. The functions 211 to 213 are each not limited to those realized by a single processing circuitry. A plurality of independent processors may be combined into processing circuitry, and each of the processors may execute the programs to implement the functions 211 to 213.

By implementing the obtainment function 211, the processing circuitry 21 obtains processing target data and a target model. The processing target data is real data to be processed by a target model. The processing target data is the same type as calibration training data and target training data. The target model is a machine learning model trained by the apparatus of machine learning 100 and in such a manner as to receive input data, such as processing target data, as input and to output inference data corresponding to the processing target data. The processing target data and the target model are stored in the memory device 23.

By implementing the inference function 212, the processing circuitry 21 applies processing target data to a target model, thereby outputting inference data corresponding to the processing target data.

By implementing the function of controlling display devices 213, the processing circuitry 21 causes the display device 25 to display various types of information. For example, the processing circuitry 21 causes processing target data, inference data, etc., to be displayed.

The memory device 23 is a memory device such as a ROM, a RAM, an HDD, an SSD, or an integrated circuit memory device, which stores various types of data. The memory device 23 may be not only these memory devices but also a driver that writes and reads various types of information in and from, for example, a portable storage medium such as a CD, a DVD, or a flash memory, or a semiconductor memory.

The display device 25 displays various types of data in accordance with the function of controlling display devices 213 of the processing circuitry 21. As the display device 25, for example, a liquid crystal display, a CRT display, an organic EL display, a plasma display, or any other display may be used as appropriate. Alternatively, the display device 25 may be a projector.

The input interface 27 accepts various input operations from a user, converts the accepted input operations into electric signals, and outputs the electric signals to the processing circuitry 21. Specifically, the input interface 7 is coupled to an input device such as a mouse, a keyboard, a track ball, a switch, a button, a joystick, a touch pad, and a touch panel display. The input interface 27 outputs the electric signals to the processing circuitry 21 according to an input operation on the input device. The input device coupled to the input interface 27 may be an input device provided on another computer and coupled via a network, etc. The input interface 27 may also be a voice recognition device configured to convert voice signals collected via a microphone into command signals.

The communication interface 29 is an interface coupled to various computers via a (LAN), etc. A LAN card, a network adopter, a network interface card, etc., are used as the communication interface 29. For example, the communication interface 29 performs data communication with a generation device or a storage device of process training data Furthermore, the communication interface 29 performs data communication with the apparatus of machine learning 100 in order to receive a target model.

FIG. 22 is a diagram showing an input/output relationship of a target model. As shown in FIG. 22, the target model is a machine learning model trained in such a manner as to receive real data of a processing target as input and to output inference data corresponding to the real data. For example, real data of a processing target is obtained from the generation device or storage device of the real data via the communication interface 29. Alternatively, in the case of the memory device 23 storing real data of a processing target in advance, the real data may be obtained from the memory device 23 A target model is obtained from the apparatus of machine learning 100 via the communication interface 29. Alternatively, in the case of the memory device 23 storing a target model in advance, the target model may be obtained from the memory device 23

For example, in the case where a task of the target model is position detection of a measurement voxel of MR spectroscopy, an MR image is input as real data, and an ROI mark indicative of a position of the measurement voxel or an MR image on which the ROI mark is superimposed is output as inference data.

The target model according to the present embodiment is suppressed in terms of individual characteristics in label assignment through the use of a correct label in machine learning, so that the accuracy of inference data is expected to be high.

According to at least one embodiment described in the above, the accuracy of machine learning through use of a label can be improved.

The term “processor” used herein refers to, for example, a CPU or a GPU, or various types of circuitry, such as an application-specific integrated circuit (ASIC), a programmable logic device (e.g., a simple programmable logic device (SPLD), a complex programmable logic device (CPLD), or a field programmable gate array (FPGA)), and so on. The processor reads programs stored in storage circuitry and executes them to realize the intended functions. The programs may be incorporated in the circuitry of the processor, instead of being stored in the storage circuit. In this case, the processor reads the programs incorporated in its circuitry and executes them to realize the functions. The function corresponding to the program may be realized by a combination of logic circuits, not by executing the program. Each processor of the present embodiment is not limited to the one configured as a single circuit; a plurality of independent circuits may be combined into one processor to implement the function of the processor. Furthermore, a plurality of components in FIG. 1 or FIG. 21 may be integrated into one processor to implement their functions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An apparatus of machine learning comprising:
processing circuitry configured to train, by using a first calibration model that receives, as input, first processing data and a first processing label assigned by a first user to the first processing data, and outputs calibration data relating to calibration of individual characteristics in label assignment by the first user, a target model based on at least the first processing data and the calibration data or a calibration label having individual characteristics calibrated using the calibration data.

2. The apparatus of machine learning according to claim 1, wherein the processing circuitry is configured to:
generate, as the calibration data, a calibration parameter with respect to the first processing label by applying the first calibration model to the first processing data and the first processing label;
generate the calibration label by applying the calibration parameter to the first processing label; and
train the target model based on the first processing data and the first calibration label.

3. The apparatus of machine learning according to claim 1, wherein the processing circuitry is configured to:
generate, as the calibration data, the calibration label by applying the first calibration model to the first processing data and the first processing label; and
train the target model based on the first processing data and the calibration label.

4. The apparatus of machine learning according to claim 1, wherein the processing circuitry is configured to:
output, as the calibration data, a reliability with respect to the first processing label by applying the first calibration model to the first processing data and the first processing label; and
train the target model based on the first processing data and the first processing label by using the reliability as a parameter of a loss function.

5. The apparatus of machine learning according to claim 1, wherein the processing circuitry is configured to generate the first calibration model based on first input training data, a first training label assigned by the first user to the first input training data, and the calibration data.

6. The apparatus of machine learning according to claim 5, wherein the processing circuitry is configured to assign the first training label to the first input training data in accordance with an instruction by the first user.

7. The apparatus of machine learning according to claim 5, wherein the first input training data is medical data generated by a medical device.

8. The apparatus of machine learning according to claim 5, wherein the first input training data is an MR image in which a measurement voxel by MR spectroscopy with a magnetic resonance imaging apparatus is set, and
the first training label is a mark indicative of a position of the measurement voxel.

9. The apparatus of machine learning according to claim 5, wherein the processing circuitry is configured to:
calculate, from the first training label, a calibration parameter for calibrating individual characteristics in label assignment by the first user; and
train, based on the first input training data, the first training label, and the calibration parameter, the first calibration model configured to receive input data as input, and to output as the calibration data a calibration parameter corresponding to the input data.

10. The apparatus of machine learning according to claim 5, wherein the processing circuitry is configured to train, based on the first input training data, the first training label, and a correct label with respect to the first input training data, the first calibration model that receives, as input, input data and a label assigned by the first user to the input data and outputs, as the calibration data, a correct label for the input data.

11. The apparatus of machine learning according to claim 5, wherein the processing circuitry is configured to.
determine a reliability of the first training label with respect to the first input training data; and
train the first calibration model that receives, as input, input data and a label assigned by the first user to the input data based on the first input training data, the first training label, and the reliability, and outputs a reliability of the label with respect to the input data.

12. The apparatus of machine learning according to claim 5, wherein the processing circuitry is configured to train the target model based on a combination of the first processing data, the first processing label, and the first calibration model and a combination of second processing data, a second processing label assigned by a second user to the second processing data, and a second calibration model for calibrating individual characteristics in label assignment by the second user.

13. The apparatus of machine learning according to claim 5, wherein the processing circuitry is configured to train the target model based on a combination of the first processing data, the first processing label assigned by the first user to the first processing data under a first assignment condition, and the first calibration model, and a combination of second processing data, a second processing label assigned by the first user to the second processing data under a second assignment condition,
the first calibration model is a calibration model for calibrating individual characteristics in label assignment by the first user under the first assignment condition, and
the second calibration model is a calibration model for calibrating individual characteristics in label assignment by the first user under the second assignment condition.

14. The apparatus of machine learning according to claim 1, wherein the target model is a machine learning model trained in such a manner as to receive input processing data as input and to output prediction data corresponding to the input processing data.

15. The apparatus of machine learning according to claim 1, wherein the processing circuitry is configured to train an untrained first calibration model by copying a training parameter of a trained calibration model corresponding to a user other than the first user to the untrained first calibration model, and training a training parameter of the untrained first calibration model based on the first input training data, the first training label, and the calibration data.

16. The apparatus of machine learning according to claim 1, wherein the first calibration model includes a plurality of calibration models respectively corresponding to a plurality of users other than the first user, and an addition layer that weight-adds a plurality of calibration data pieces from the calibration models in accordance with a weight trained for calibration of label assignment by the first user, and outputs the calibration data pieces.

17. A machine learning method comprising: training, by using a calibration model that receives, as input, processing data and a processing label assigned by a user to the processing data, and outputs calibration data relating to calibration of individual characteristics in label assignment by the user, a target model based on at least the processing data and the calibration data or a calibration label having individual characteristics calibrated using the calibration data.

18. An inference apparatus comprising processing circuitry configured to make an inference with a model trained using a calibration model that receives, as input, processing data and a processing label assigned by a user to the processing data, and outputs calibration data relating to calibration of individual characteristics in label assignment by the user, based on at least the processing data and the calibration data or a calibration label having individual characteristics calibrated using the calibration data.
